(19) United States
(12) Patent Application Publication
(10) Pub. No.: US 2001/0020642 A1
(43) Pub. Date: Sep. 13, 2001

(54) IC CARD AND IC CARD SYSTEM HAVING PROTECTIVE SEAL

(76) Inventor: SHIGEO ONODA, TOKYO (JP)

Correspondence Address: MCDERMOTT WILL & EMERY, 600 13TH STREET, N.W., WASHINGTON, DC, 20005-3096, US

(21) Appl. No.: 09/170,222

(22) Filed: Oct. 13, 1998

(30) Foreign Application Priority Data
Apr. 8, 1998 (JP) 10-095772

(51) Int. Cl. G06K 7/06

(52) U.S. Cl. 235/441

(57) ABSTRACT

An IC card having a simple construction whereby deterioration of the connector and internal circuits of an unused IC card is prevented at the seaside and in such inclement environmental conditions as outdoors in the rain, and penetration of water, dust, and foreign contaminants to the connector is prevented after the IC card is used. The IC card has a female connector with a plurality of pin insertion holes, and a seal that is waterproof, insulative and pierceable by a pin of the male connector, and covers the open front of all pin insertion holes of the female connector.

### BACKGROUND OF THE INVENTION

1. Field of the Invention

The present invention relates to an IC card having a female connector of a specific shape, and relates more specifically to a protective structure for the connector and internal circuits of the IC card.

2. Description of the Related Art

FIG. 11 is a perspective view of an IC card 201 according to the prior art. FIG. 12 is a sectional view of the IC card 201 along line XII-XII in FIG. 11. As shown in the figures, this IC card 201 comprises a circuit board 203 on which is mounted a plurality of electronic parts 202, and a female connector 204. The circuit board 203 is connected to the female connector 204, and then housed in a frame 205. The frame 205 is a rectangular member to which a top panel 206a and a bottom panel 206b are bonded with an adhesive sheet, for example, to seal the inside of the frame 205.

An IC card 201 thus configured can be connected to a card drive of an electronic device where the card drive has a male connector compatible with the female connector 204 of the IC card 201. Examples of such electronic devices include digital cameras and portable information terminals such as personal digital assistant (PDA) devices and notebook computers. An enlarged view of this female connector 204 is shown in FIG. 13.

As shown in FIG. 13, the female connector 204 typically has a plurality of insertion holes 208. When the IC card 201 is inserted to the card slot (drive) of an electronic device, each connector pin 257 of the card drive is inserted to the matching insertion hole 208 of the female connector 204. A contact pin 209 is press fit inside each insertion hole 208, and is connected to a circuit on the circuit board 203. Inserting the connector pins 257 to the matching insertion holes 208 therefore results in an electrical connection with the corresponding contact pin 209 and internal circuits of the IC card, and connects the IC card 201 to the card drive for use.

The insertion holes 208 of the female connector 204 in an IC card 201 as shown in FIG. 12 and FIG. 13 are always open when the IC card 201 is not mounted in a card drive, and particularly when the connector pins 257 of the card drive are not inserted to the insertion holes 208. As a result, dust and other foreign matter can easily penetrate into the insertion holes 208 and result in poor contact between the pins.

IC cards are also very likely to be used outdoors due to the rapid accpetance of digital cameras and other types of portable electronic devices that can use IC cards. Outdoor use also increases the potential for exposure to factors resulting in poor electrical contact between the connector pins. For example, when a digital camera with an IC card is used outside, and particularly when used at the beach, rainwater, sea spray, and even salt air can penetrate the IC card through the insertion holes 208, causing the female connector 204 and the wiring of the internal circuit board 203 to corrode. The same problem occurs when the IC card is used in a high temperature, high humidity environment, or when the IC card is dropped in a puddle of water. Furthermore, if sea spray or rainwater gets into the female connector 204 through the insertion holes 208 when the IC card is not loaded in a card drive, the water or salt will also transfer to the mated connector pins 257 of the card drive when the IC card is then mounted for use. This will obviously also cause the connector pins 257 to corrode, contribute to circuit shorts, and even adversely affect the connectors of other IC cards that may subsequently be used in the damaged card drive.

In an attempt to resolve this problem, an IC card as taught by Japanese Patent Laid-Open Publication No. 7-52590 features a protective member made from a resilient material fastened to the front of the connectors of the IC card. This protective member has a plurality of cross-scored openings or slits designed to prevent the penetration of moisture and dust to the pin insertion holes of the IC card connector. The male connector pins of the card drive spread the cross-scored openings or slits open as the male pins are inserted to the female connector.

The problem with this design when applied to a Type II PCMCIA-standard IC card is that there are 34 pin insertion holes provided in two rows in a connector that is 54 mm wide. As a result, the spacing between adjacent pin insertion holes is extremely narrow. It is therefore difficult to form cross-scored slits in the resilient material conforming precisely to the arrangement of the pin holes, and even if the slits can be accurately formed, the narrow spacing creates problems with the strength of the resilient material and obstruction of the pin holes. It is also difficult to assure a high degree of airtightness inside this typical IC card. It is therefore not possible to completely prevent the penetration of water when the IC card is dropped in a puddle, for example, or when the IC card is exposed to salt air due to use at the seaside, for example.

For the same purpose, the above-cited Publication H7-52590 further teaches an IC card having a protective member made from a rubber or other resilient material that can be punctured by the male connector pins of the card drive connector. This protective member is held by the elasticity of the material in front of the female connector of the IC card. However, with the protective member held only by the elasticity of the resilient material, the force holding the protective member around the IC card connector is weak. This makes it difficult to maintain a high degree of airtightness inside the card. As a result, it is again not possible to completely prevent the penetration of water when the IC card is dropped in water, or when the IC card is exposed to salt air due to use at the seaside, for example.

Other attempts have also been made to prevent the penetration of dust and other foreign contaminants. Japanese Utility Model Laid-Open Publication No. 63-11866, for example teaches an IC card comprising a woven filter made from a stretchable insulating fiber on an end of the IC card. Japanese Utility Model Laid-Open Publication No. 63-47180 teaches an IC card comprising a protective cover on an end of the IC card that is only opened during use. Airtightness inside the card, and particularly airtightness when the card is not used, is not assured by either of these designs, however, and they cannot completely prevent the penetration of water when the IC card is dropped in water, or when the IC card is exposed to salt air due to use at the seaside, for example.

Japanese Patent Laid-Open Publication No. 7-239925 teaches an IC card in which a seal is disposed between the connector and internal circuits to create an airtight seal around the internal circuits. This card can therefore protect the internal circuits of the card from adverse environmental factors, including high humidity and large temperature changes, but cannot prevent penetration by water or salt air to the external connectors.

It should be noted that penetration of water, dust, and other foreign contaminants to the connector and the inside of the card can be prevented by combining various technologies according to the related art as described above. This, however, complicates the construction and thus leads to higher cost. Furthermore, an airtight seal around the connector cannot be assured even when these technologies are used in combination, and it is therefore obviously not possible to prevent penetration of salt air during use near the sea, or to prevent penetration of water to the connector when dropped in water.

There is therefore a need for an IC card of simple construction whereby deterioration of the IC card connectors and internal circuits can be completely prevented during use near the sea or outdoors during inclement weather, and penetration of water, dust, and other foreign matter to the connector after the IC card is used can be prevented.

### SUMMARY OF THE INVENTION

To address the above described need, an IC card according to the present invention comprises a female connector with a plurality of pin insertion holes corresponding to the pins of a male connector, and a seal that is waterproof, insulative and pierceable by the pins of the male connector. The seal covers the front of all pin insertion holes of the female connector, and forms an airtight seal protecting all of the pin insertion holes. By thus forming an airtight seal, the inside of the card is kept airtight when the IC card is not in use, and rainwater and other foreign matter is kept from penetrating the connector or card.

The seal of this IC card is preferably made from a resilient material with self-restoring force. This self-restoring force causes the holes formed by inserting the male connector pins to close, thereby maintaining a level of airtightness after the IC card is used and effectively preventing penetration of dust and other foreign matter to the card.

If the seal is further disposed in a manner enabling the seal to be removed and replaced to the front of all pin insertion holes of the female connector, the seal can be selectively used as required, and the original airtight state of the unused seal can be restored at any time. When the seal is thus removably disposed, a member for holding the seal when removed from in front of the connector is preferably provided opposite the connector or at another position not interfering with IC card use when the seal is held thereon.

The present invention also addresses an IC card system. An IC card system according to the present invention comprises a card drive having a male connector with a plurality of contact pins, and a female connector with pin insertion holes corresponding to the contact pins of the male connector where the front of the pin insertion holes of the female connector is covered and sealed by a seal that is waterproof, insulative, and pierceable by the pins of the male connector. With this IC card system, dust, foreign matter, saltwater, rainwater, and other contaminants cannot penetrate the pin insertion holes or inside of the unused IC card. When the IC card is then used in this IC card system, salt water or rainwater will not contact the male connector contact pins of the card drive. As a result, the pins will not corrode, and further adverse effects on a separate IC card subsequently used in the card drive can be prevented. Consistently reliable data and signal transfer operations can therefore be assured.

### BRIEF DESCRIPTION OF THE DRAWINGS

These and other objects and features of the present invention will be readily understood from the following detailed description taken in conjunction with preferred embodiments thereof with reference to the accompanying drawings, in which like parts are designated by like reference numerals and in which:.

FIG. 1 is a schematic plan view of an IC card according to a first embodiment of the present invention, and an IC card system comprising a card drive in which said IC card is used;

FIG. 2 is a schematic perspective view of the IC card shown in FIG. 1;

FIG. 3 is a schematic perspective view of the IC card shown in FIG. 1 partially disassembled;

FIG. 4 is a schematic side section of view of the IC card shown in FIG. 1 along line IV-IV in FIG. 2;

FIG. 5A is a partially enlarged view of the connector of the IC card shown in FIG. 1;

FIG. 5B is a partially enlarged view of a connector pin inserted to a connector of the IC card in FIG. 5A;

FIG. 6A is a perspective view of an IC card 20 according to a second embodiment of the present invention;

FIG. 6B is a side section view of the connector 12 shown in FIG. 6A through line VIB-VIB in FIG. 6A;

FIG. 6C is a side section view of the connector 12 shown in FIG. 6A through line VIC-VIC in FIG. 6A;

FIG. 7 is a shcematic perspective view of an IC card according to a third embodiment of the present invention;

FIG. 8 is a schematic perspective view of the IC card shown in FIG. 7 partially disassembled;

FIG. 9A is a schematic perspective view of an IC card according to a fourth embodiment of the present invention;

FIG. 9B is a partial sectional view of the IC card along line IXB-IXB of FIG. 9A;

FIG. 10 is a schematic perspective view of the IC card shown in FIG. 9A partially disassembled;

FIG. 11 is a schematic perspective view of an IC card according to the prior;

FIG. 12 is a sectional view of the IC card along line XII-XII of in FIG. 11; and

FIG. 13 is an enlarged view of the connector of the IC card shown in FIG. 11.

### DETAILED DESCRIPTION OF THE PREFERRED EMBODIMENTS

The preferred embodiments of the present invention are described below with reference to the accompanying drawings.

Embodiment 1

FIG. 1 is a typical plan view of an IC card 1 according to a first embodiment of the present invention, and part of a card drive 100 in which said IC card 1 is used. The card drive 100 comprises a male connector 102 of a specific shape and having a plurality of pins 101. The ends of the pins 101 in the connector 102 are preferably pointed.

The IC card 1 has a female connector 4 that is compatible with the male connector 102. A shield cover 10 is bonded to the front of the female connector 4, that is, the side of the connector 4 at the leading edge of the IC card 1 when inserted to the card drive 100. This shield cover 10 is made from a resilient material, such as rubber, that is both waterproof and insulative.

Resilient materials that can be used for the shield cover 10 include chloroprene rubber, nitrile rubber, propylene rubber, silicon rubber, and fluoroelastomers. The shield cover 10 shall not be so limited, however, and can essentially be manufactured from any material that is pierceable by the pins 101, is waterproof and dielectric, and has sufficient self-restoring force to close holes opened by the pins 101. In practice, the material used for the shield cover 10 is chosen with consideration also given to such properties as tensile strength, stretchability, tear resistance, and wear resistance, in addition to self-restoring force.

The card drive 100 can be integrated to a digital camera, notebook or desktop computer, personal digital assistant or other type of portable electronic device. The construction and operation thereof is known in the literature, and further description is therefore omitted below.

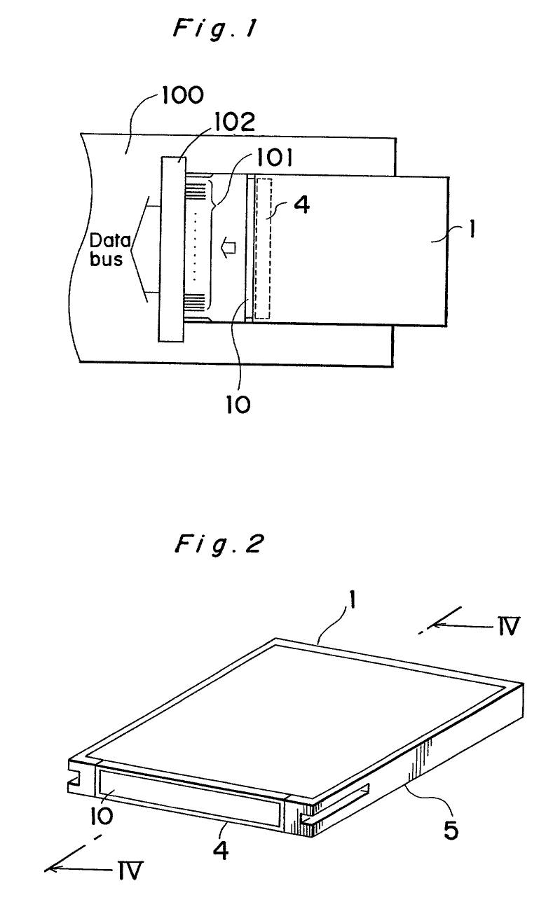

FIG. 2 is a perspective view of the IC card 1 in FIG. 1. A shield cover 10 that is waterproof, dielectric, and can be pierced by the pins 101 of the card drive connector as described above is provided covering the front of all pin insertion holes (not shown in the figure) of the IC card connector 4.

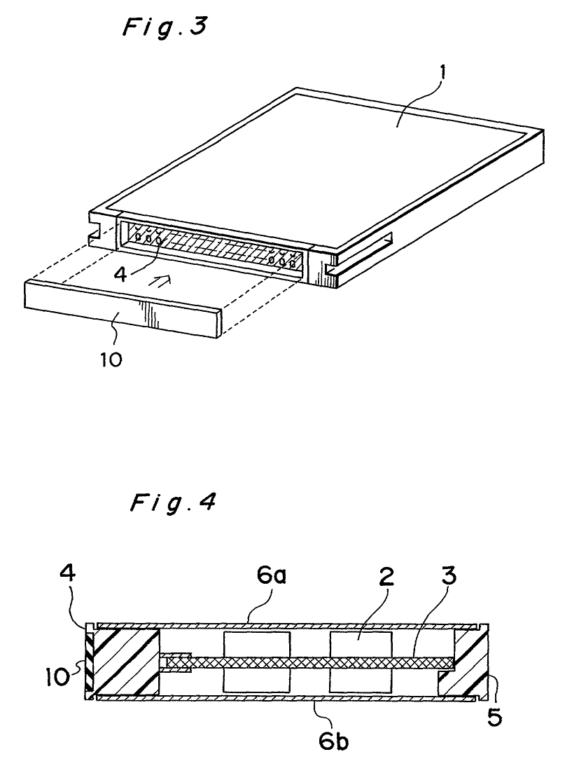

FIG. 3 is a perspective view of the IC card 1 with the shield cover 10 removed. Note that the shield cover 10 is attached by adhesive to form a completely airtight seal around all pin insertion holes of the connector 4.

FIG. 4 is a side section view of the IC card 1 through line IV-IV in FIG. 2. As shown in the figure, the IC card 1 also comprises a circuit board 3 on which is mounted a plurality of electronic parts 2. The circuit board 3 is connected to the female connector 4, and then housed in a frame 5. A top panel 6a and a bottom panel 6b, as seen in FIG. 4, are bonded to the frame 5 using an adhesive sheet, for example, to seal the inside of the frame 5. The shield cover 10 is then applied with adhesive to the front of the connector 4.

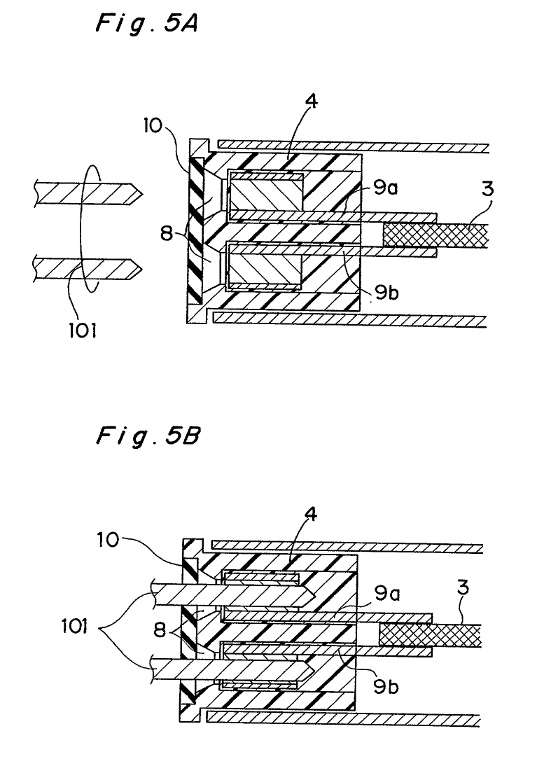

FIGS. 5A and 5B are enlarged side views of the connector 4. FIG. 5A shows the connector 4 before the pins 101 of the male connector 102 of the card drive 100 are inserted to the connector 4. Insertion holes 8 are provided in the connector 4 at positions corresponding to the pins 101. A contact pin 9a and 9b is press fit into each insertion hole 8, and is connected to the wiring pattern of the circuit board 3 as required.

Note that there are no holes open in the shield cover 10 before the pins 101 are inserted, and an airtight seal around the inside of the IC card 1 is thus assured. Penetration of saltwater, rainwater, humid air, dust, and other foreign contaminants to the inside of the IC card 1, which includes the connector 4, can therefore be completely prevented without housing the IC card 1 in a special case and without providing a special cover over the connector 4.

Note that because penetration of saltwater, rainwater, humid air, dust, and other foreign contaminants to the inside of the connector 4 can be prevented when the IC card 1 is unused, the transfer of seawater, for example, to the pins 101 of the card drive 100 when the IC card is used can be prevented, and circuit shorting resulting therefrom can be prevented. As a result, consistently accurate data communications between the IC card 1 and the card drive 100 can be maintained.

FIG. 5B shows the IC card connector 4 when the pins 101 of the male connector 102 of the card drive 100 mate with the corresponding connector and contact pin. As shown in the figure, the pins 101 pierce the resilient shield cover 10 in order to penetrate an insertion hole 8 and contact the corresponding contact pin 9. This electrically connects the card drive 100 and IC card 1.

The holes opened in the shield cover 10 by the pins 101 are extremely small in comparison with holes that are prescored in a cross shape or are preopened to approximately the same size as the insertion hole 8. After the pins 101 are removed, the holes are closed substantially completely by the self-restoring force of the shield cover 10 material. It is therefore possible to effectively prevent penetration of moisture and foreign materials to the insertion holes 8 even after the IC card has been used.

The connector 4 of the IC card 1 can be any female connector that is compatible with the mated male connector of the card drive 100 in which the IC card 1 is used. An IC card 1 according to the present invention is therefore specifically not limited to IC cards conforming to the PCMCIA standard or the Compact Flash Association (CFA) standard, and can therefore conform to any other desired standard. It should be noted that this is also true of IC cards according to the second through fourth embodiments described below.

Embodiment 2

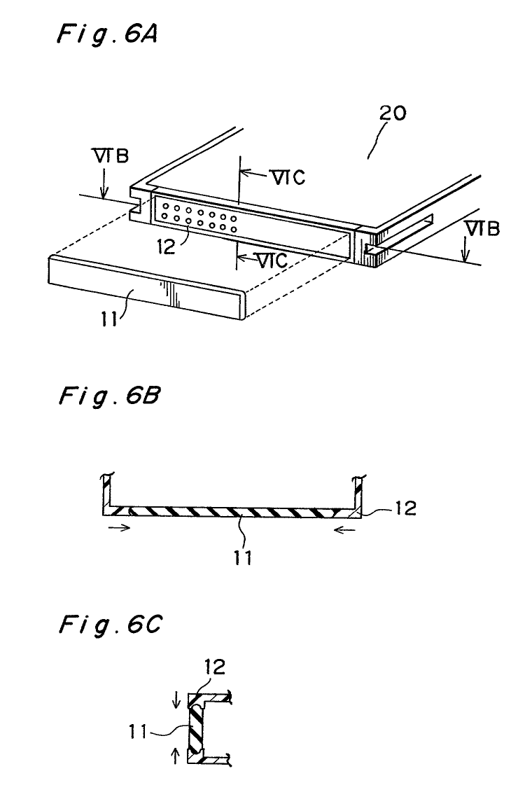

An IC card 20 according to a second embodiment of the present invention is described next with reference to FIGS. 6A, 6B, and 6C. FIG. 6A is a perspective view of an IC card 20 according to a second embodiment of the present invention, FIG. 6B is a side section view of the connector 12 along line VIB-VIB in FIG. 6A, and FIG. 6C is a side section view of the connector 12 along line VIC-VIC in FIG. 6A.

As shown in FIG. 6B and FIG. 6C, the shield cover 11 of an IC card 20 according to this second embodiment has a protruding rib formed around the outside edge of the cover, and the connector 12 to which the shield cover 11 is fit and fixed has a frame member in which a channel matching the rib of the shield cover 11 is formed. The connector 12 and inside circuits of the IC card 20 can be completely sealed and made airtight by fitting the shield cover 11 to the connector 12.

The shield cover 11 configuration according to this embodiment makes it possible to replace the shield cover 11 as required, and makes it possible to restore a used IC card 20 to the same airtight condition as an unused IC card 20.

It should be noted that the effects of sealing the connector 12 and the inside of the IC card 20 airtight by means of the shield cover 11 are the same as those of an IC card 1 according to the first embodiment above.

The material from which the shield cover 11 is made can be the same as the material used for the shield cover 10 of the IC card 1 according to the first embodiment, that is, a rubber or other resilient, waterproof, insulative material that can be pierced by the pins of the matching male connector. In addition, however, the material of this shield cover 11 must have strength sufficient to hold the shield cover 11 fit to the front of the connector 12. The shield cover 11 can therefore have a thick perimeter and a thin wall in the area opposite the insertion holes 8. Alternatively, a plastic or other relatively hard material can be used in the perimeter, and a rubber or other resilient material can be used in the area opposite the insertion holes 8 of the connector 12.

Embodiment 3

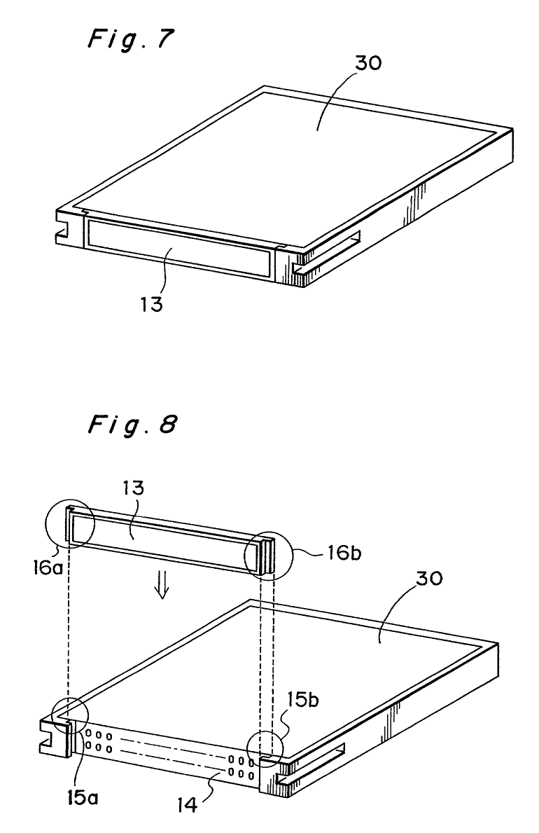

An IC card 30 according to a third embodiment of the present invention is described next with reference to FIG. 7, a perspective view, and FIG. 8, a perspective view of the IC card 30 with the shield cover 13 thereof removed.

As shown in the figures, the shield cover 13 of an IC card 30 according to the present embodiment has guides 16a and 16b of a specific configuration on opposite ends of the shield cover 13. The matching connector 14 has guide channels 15a and 15b of a configuration matching the guides 16a and 16b of the shield cover 13.

The shield cover 13 is fit to the connector 14 by sliding the guides 16a and 16b thereof into the guide channels 15a and 15b in the direction indicated by the arrow in FIG. 8. When thus fit, the connector 14 and inside of the IC card 30 are sealed completely airtight. It should be noted that to assure a reliable fit to the connector 14, the shield cover 13 is made with a perimeter of plastic or other relatively hard material, and a rubber or other resilient material in the area opposite the insertion holes of the connector 14. A resilient material of a specific hardness can also be used for the shield cover 13 itself while using a thin rubber or other resilient material with sufficient self-recovering force in the area opposite the insertion holes of the connector 14.

An advantage of using this shield cover 13 compared with the shield cover 11 of the second embodiment is that the shield cover 13 can be removed and replaced more easily. The other effects and benefits of this embodiment are the same as those of the IC card 20 according to the second embodiment.

Embodiment 4

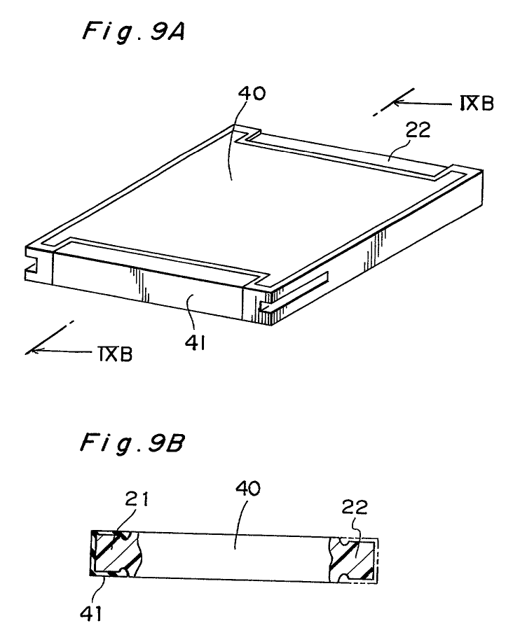

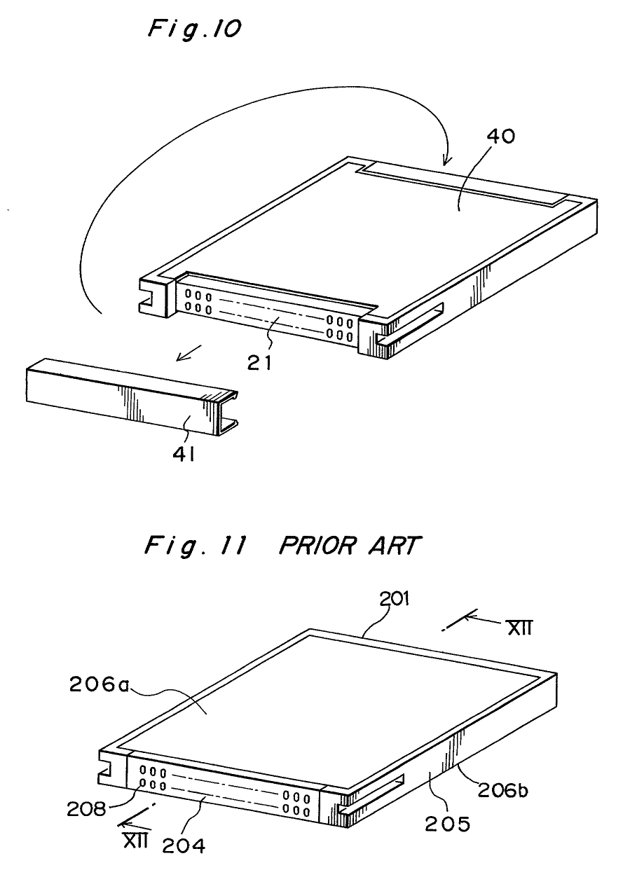

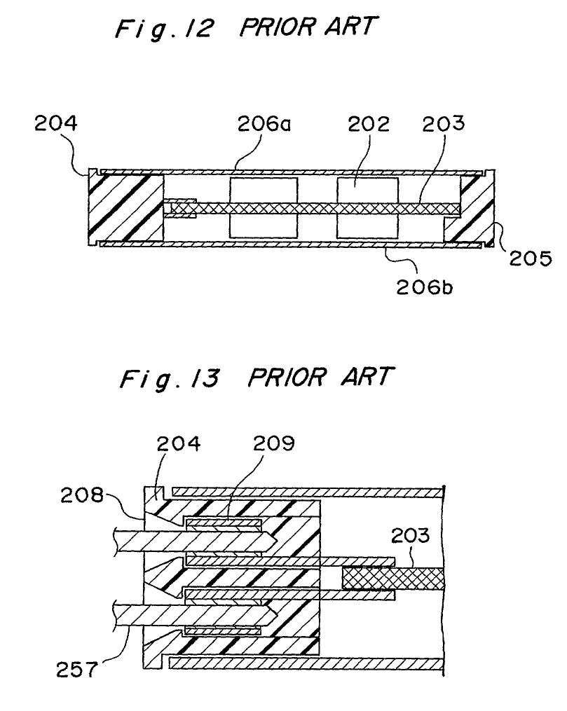

An IC card 40 according to a fourth embodiment of the present invention is described next with reference to FIGS. 9A and 9B. FIG. 9A is a perspective view of an IC card 40 according to this fourth embodiment of the invention, and FIG. 9B is a side section view thereof through line IXB-IXB in FIG. 9A.

As shown in FIG. 9B, the shield cover 41 of this embodiment is removably fit to the connector 21 of the IC card 40 such that the connector 21 is partially contained within shield cover 41. The shield cover 41 is a waterproof, insulative material that can be pierced by the pins of the matching male connector, and forms a completely airtight seal over all pin insertion holes of the connector 21. A shield cover holder 22 for holding the shield cover 41 when not in use on the connector 21 is provided on the side opposite the connector 21. Note, however, that the shield cover holder 22 can be provided at any place other than in front of the connector 21 insofar as use of the IC card 40 is not inhibited when the shield cover 41 is mounted to the shield cover holder 22.

FIG. 10 shows the IC card 40 with the shield cover 41 removed. As indicated by the two arrows in FIG. 10, the shield cover 41 can be removed from the connector 21 and held on the shield cover holder 22 of the IC card 40.

When the IC card 40 is used at the seaside or outdoors in inclement weather, the shield cover 41 can be fit over the connector 21 to form an airtight seal around the connector 21 and card interior, and thus prevent penetration of salt water, rain, dust, and other foreign materials. When the IC card 40 is used indoors, and particularly where there is no particular concern about dust or moisture penetrating the card or connector holes, the shield cover 41 can be removed from the connector 21 and stored on the shield cover holder 22. Unnecessary piercing of the shield cover 41 by the pins can thus be reduced, and the service life of the shield cover 41 can thus be extended. The other effects and benefits of this embodiment are the same as those of the IC card 20 according to the second embodiment.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

What is claimed is:

1. An IC card comprising a female connector with a pin insertion hole corresponding to a pin of a male connector, and
a seal that is waterproof, insulative and pierceable by a pin of the male connector,
wherein the seal seals airtight the front of all pin insertion holes of the female connector.

2. The IC card according to claim 1, wherein the seal is made from a resilient material with self-restoring force.

3. The IC card according to claim 1, wherein the seal is removably disposed in front of all pin insertion holes of the female connector.

4. The IC card according to claim 3, further comprising a holding member for holding the seal at a position other than in front of the connector.

5. An IC card system comprising a card drive having a male connector with a plurality of contact pins, and
an IC card comprising a female connector with a pin insertion hole corresponding to a contact pin of the male connector, and
a seal that is waterproof, insulative and pierceable by a pin of the male connector,
wherein the seal seals airtight the front of all pin insertion holes of the female connector.
